(19) United States
(12) Patent Application Publication
(10) Pub. No.: US 2014/0301091 A1
(43) Pub. Date: Oct. 9, 2014

(54) MEANS FOR SELECTIVE MOUNTING OF AN ILLUMINATED OR A TRANSLUCENT OBJECT

(71) Applicant: Anders Rensmo, Orebro (SE)

(72) Inventor: Anders Rensmo, Orebro (SE)

(21) Appl. No.: 14/355,259

(22) PCT Filed: Oct. 12, 2012
(86) PCT No.: PCT/SE2012/051095

§ 371 Date: Apr. 30, 2014

(30) Foreign Application Priority Data
Oct. 31, 2011 (SE) 1151016-1

(51) Int. Cl. F21S 8/04; F21V 21/26; F21S 8/00

(52) U.S. Cl. CPC F21S 8/043; F21S 8/00; F21V 21/26
USPC 362/404

(57) ABSTRACT

A mounting element for selective mounting of an object (1) for illumination or for transmission of light from a light source arranged behind the object, including two or more arms (5) which are arranged in one end (7) to be mounted so as to depend from a ceiling or to project from a wall, and in another and free end (6) are arranged to detachably engage, by a biasing force, in one of at least two alternative arresting seats (10, 16, 17) arranged to this purpose on an inner side of a frame (4) carrying the object, wherein a first of the arresting seats (10) is arranged to hold the frame into contact with the ceiling or the wall, and a second arresting seat (16; 17) is arranged to hold the frame while forming a gap (14) between the frame and the ceiling or wall.

### TECHNICAL FIELD

The invention refers to a means adapted for selectively mounting of an illuminated or a translucent object in alternative positions with respect to a wall or a ceiling.

### BACKGROUND AND PRIOR ART

The invention emanates from a desire to access a universally useful mounting means for light panel signs and symbols. Light panel signs and symbols having light emitting front panels adapted to transmit light from a light source arranged behind the light panel are well known in the field of displaying. Beside the translucent objects there are also symbols such as letters, numerals or logotypes having front panels which are impervious to light and adapted to be exposed by a surrounding ring of light or a corona of light. Typically, a corona may be generated as the light from a rear light source or from a built-in light source is allowed to escape via a light slot or gap that is formed between the object and the wall onto which the object is mounted. Combinations are also possible, wherein a translucent object is additionally illuminated from a surrounding corona of light.

The mounting of signs and symbols usually involves different types of attachment means and mounting steps depending on whether the object is intended to transmit light or to be illuminated. For this reason, mounting usually includes a substantial amount of individual adjustment to the object in question.

### SUMMARY OF THE INVENTION

The object of the invention is to provide a universally useful means for mounting of objects intended for transmission of light or to be illuminated from a built-in or a rear-mounted light source, said means permitting selective mounting of the object onto a wall.

The mounting means is however also suitable for mounting of a translucent or illuminated object to a ceiling. It should however be pointed out that in this context the word object shall be understood to include objects which are intended for lighting purposes, beside the light panel signs and symbols.

The object of the invention is met through a means comprising two or more arms which are arranged, in a first of their ends, to be mounted so as to depend from a ceiling or to project from a wall, and in a second free end, respectively, arranged to engage detachably, under a biasing force, one of at least two alternative arresting seats which are formed for this purpose on an inner side of a frame that carries the object, wherein a first arresting seat is arranged to hold the frame and/or the object in contact with the ceiling or the wall, and a second arresting seat is arranged to hold the frame under formation of a gap between the frame/object and the ceiling or wall.

In other words, an element is provided to function like an adapter to which the object can be coupled in order selectively to be supported for transmission of light and/or to be illuminated from a light source that is arranged behind the object.

The frame has an axial extension from a first end to a second end. Preferably, the arresting seats on the inner side of the frame are realized as depressions or grooves running in parallel in the circumferential direction, at least for a portion of the length of the frame. In their respective free ends, the arms may be formed with a bulge or heel that is sized to engage said grooves. The grooves may have limited lengths or they may run continuously about the inner side of the frame. Preferably, the grooves are at least long enough to avoid the need for an exact positioning of the arms upon mounting.

Furthermore it is preferred that the frame has at least two additional arresting seats beside the first arresting seat in order to provide for selection between gaps of different widths.

In a preferred embodiment the heel and the first arresting seat are shaped to provide a wedging action upon engagement. It is specifically provided that the heel and the first arresting seat comprises slide surfaces that cooperate to generate a biasing force in one direction only towards the frame, and more specifically towards the wall or ceiling. This way it can be ensured that the frame when mounted is urged into contact with the wall or ceiling as the arms engage the first arresting seat. Other arresting seats may be shaped to provide, by engagement from the heel, a snap lock which holds the frame in both axial directions.

The frame is maintained in its position from a biasing force acting between the frame and the arms. Alternatively, a biasing force may be provided by designing the frame to have an inherent flexibility and ability to spring back. The required force is preferably generated by designing the arms from a flexible material. The arms may advantageously be produced from leaf springs which are bent to the shape of a semi-circular or rounded heel in the end thereof which engages the frame.

In a very simple realization the arms may be arranged for direct attachment to the wall or ceiling by means of screws.

In a further developed embodiment the arms are attached and supported in a mounting plate arranged for mounting to a ceiling or a wall. The arms may advantageously be adjustably attached to the mounting plate and adjustable in directions substantially in parallel with the main plane of the mounting plate. Sockets for one or more slight sources may be arranged within or onto the mounting plate. The mounting plate may also advantageously be configured for mounting to a ceiling lamp attachment of any standard type.

It is further preferred that the arms extend from the engagement with the frame at directions which deviate from the inner side of the frame in such way that the arms run at a distance from the edge of the frame, in said first end of the frame. Any influence from the arm on light that is emitted to form a light corona around the object is this way minimized. To this purpose, the arms may run at an angle or curved between the first end second ends of the arm.

The frame preferably runs continuously in the circumferential direction. In its first end, the frame may carry a seal arranged to be brought in contact with a ceiling or wall when the arms engage the first arresting seat.

In its second end the frame is arranged to carry a light transmitting or an opaque object, such as a light transmitting front panel, an opaque front panel, or a light transmitting object intended for lighting purposes.

### SHORT DESCRIPTION OF THE DRAWINGS

Embodiments of the invention will be further explained below with reference made to the accompanying, schematic drawings. In the drawings,

FIG. 1 is a sectional view showing the arrangement in an alternative, first mounting position;

FIG. 2 is a corresponding sectional view showing the arrangement in an alternative, second mounting position;

FIG. 3 is yet a corresponding sectional view showing an alternative embodiment of the arrangement in the second mounting position, and

FIG. 4 shows an element comprised in one embodiment of the invention.

### DETAILED DESCRIPTION OF PREFERRED EMBODIMENTS

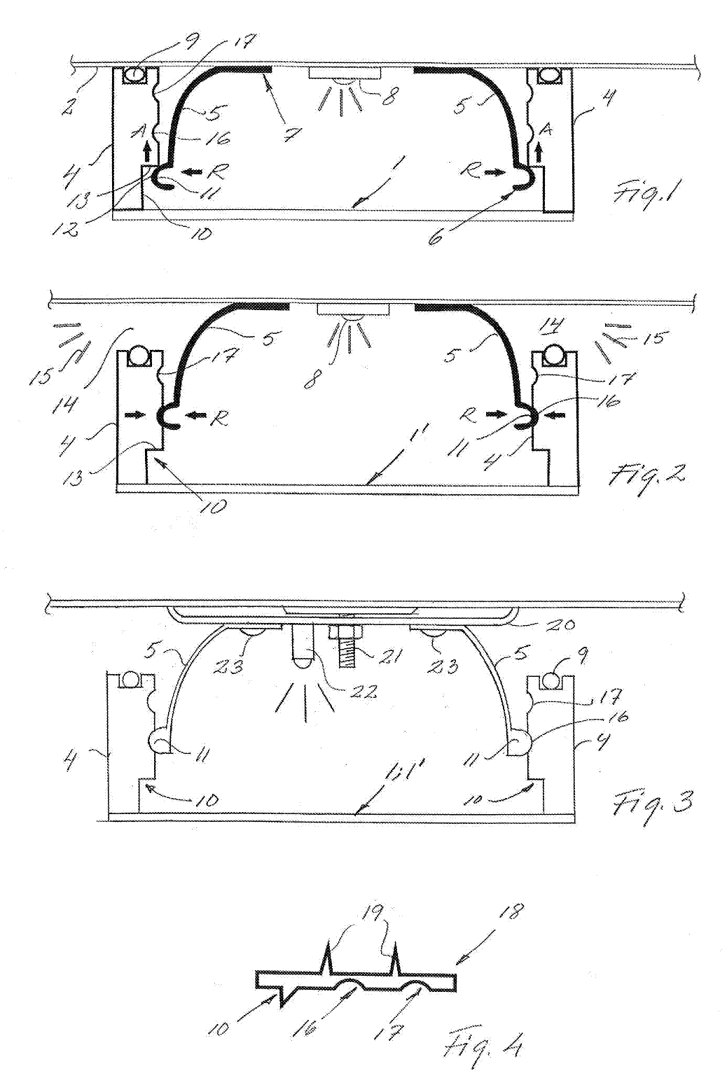

FIG. 1 shows an arrangement for alternative mounting of an object, wherein in this embodiment the object is in the form of a light transmitting front panel 1 for a light panel sign. In the embodiment of FIG. 1 the front panel is mounted horizontally onto a ceiling 2. However, the front panel might instead be mounted at a vertical orientation onto a wall in a corresponding way. The front panel 1 is supported in one end of a frame 4 which extends in axial direction between a first and a second end. In FIG. 1, the frame is mounted with its first end in contact with the ceiling 2. To this purpose the frame 4 is held by two mutually oppositely arranged arms 5, whereby a free end 6 of each arm engages an inner side of the frame 4. In its other end 7, the arms are adapted to be attached to the ceiling 2, such as by means of screws. Reference number 8 refers to light source arranged behind the front panel 1, and reference number 9 refers to a seal supported in the first end of the frame.

The arms 5 are arranged to exert a biasing force in radial direction towards the frame 4, in direction of arrows R. In the mounting position shown in FIG. 1, the forces R result in an axially directed force A which urges the frame 4 towards the ceiling. To achieve this, the frame 4 is designed with a first arresting position 10 arranged on the inner side of frame 4, and which, in cooperation with a projection or heel 11 arranged in the free end of the arm, provides a wedging effect in one axial direction A only. In the illustrated embodiment, this wedging effect is generated by slide surfaces 12 and 13 arranged on the heel and on the arresting seat, respectively. The slide surface 12 is realized by forming the heel 11 to have a rounded, or an elliptic or part-circular exterior that is pressed into the first arresting seat 10 by effect of the biasing force R and in sliding movement along a shoulder 13 which delimits the arresting seat in one axial direction of the frame 4. The shoulder 13 may alternatively be formed with a slanting or a convexly curved slide surface.

In FIG. 2, the arrangement is shown mounted in an alternative mounting position in which the frame 4 is maintained at a distance from the ceiling 2, whereby a gap 14 and an opening for emitted light from the light source 8 is formed. A ring of light or corona 15 is this way formed around the frame and object, against which the object is displayed against the background. In the mounting position illustrated in FIG. 2 the object and frame are in other words illuminated indirectly from the slight source arranged behind the object. In the illustrated example, the object is an opaque symbol 1′.

In the alternative mounting position the heels 11 are brought into engagement with a second arresting seat 16 arranged on the inner side of the frame 4. Additional arresting seats 17 may be arranged to provide even further selectable mounting positions. The arresting seats 16 and 17 can be arranged for attaching by snapping the frame to the heels 11, and may to this end be designed as bowl-shaped depressions. Preferably though, all arresting seats are realized in the form of depressions or grooves that run mutually in parallel in the circumferential direction of the frame, and in parallel with the edges in the ends of the frame. The arresting means may extend for the full length of the frame, or only for limited portions of the frame's length.

The arresting seats 10, 16 and where appropriate the arresting seat 17, may be formed integrally in the frame 4. The arresting seats may alternatively be provided in the form of a separate element 18 as illustrated in FIG. 4, the separate element arranged for mounting on the inner side of the frame. The example illustrated in FIG. 4 shows an element 18 which on one side comprises the arresting seats 10, 16 and 17, whereas the opposite side comprises pins 19 by which the element 18 in a simple way can be mounted on a frame produced from plastic ell material or soft wood.

As is shown in FIG. 3, the arms 5 may alternatively be arranged to be secured in a mounting plate 20 which in turn is mountable to a ceiling or to a wall. The mounting plate 20 may be arranged for mounting onto an attachment 21 for a ceiling lamp, for example, of any standard type. In such embodiment, the light source 8 may be arranged in a socket 22 on the mounting plate. In order to adapt to the inner dimensions of the frame, the arms 5 may be adjustably arranged in the mounting plate and by means of adjusting screws 23 movable in directions which are parallel with the mounting plate and with the main plane of the mounting plate.

Advantageously, the arms 5 are made in a material that is flexible per se. Spring steel is a preferred material durability reasons, particularly in connection with outdoor mounting of signs, symbols and light panels, which are exposed to low outdoor temperatures and to heat from the light source, as well. The heels 11 are then preferably shaped by bending an end region of a leaf spring, but may alternatively be realized as a heel or ball that is mounted onto the leaf spring.

In all of the illustrated embodiments, a feature with the arms 5 is that they deviate angularly or arcuately from the frame, towards their attachment points in a wall, or in a ceiling, or in the mounting plate 18. This feature reduces any effect the arms may have on the light that is emitted via the gap such that a light corona of substantially continuous intensity is formed about the frame and the indirectly illuminated object.

The frame 4 is advantageously formed to run uninterrupted in the region of the circumference of the object. The frame may have a regular or irregular shape. In a four-sided object, the frame is preferably secured in two or more arms 5 which engage the frame in two opposite sides of the frame only.

Notwithstanding the fact that the invention has been explained in connection with a translucent light panel 1 or an illuminated opaque symbol 1′ it will be realized that the frame 4 may also serve for support of different kind of objects intended for transmitting light or for illumination from outside, such as by a surrounding corona of light. The frame 4 may in this aspect be understood as an adapter which is useful for mounting different types of translucent/illuminated objects that can be selectively mounted in alternative position relative to a ceiling or a wall.

A mounting means according to the present invention may advantageously be used in connection with lighting armatures such as wall and ceiling lamps or light panels for lighting purposes. Thus without the use of tools, the object can easily be shifted manually from direct illumination to illumination which also includes indirect illumination from the wall or the ceiling. Since the object and the frame can easily be dismounted by pulling the frame downwards or outwards to detach the frame from the arms, shifting of lamps is simplified as well.

A feasible modification of the invention includes a frame that is adjustably connectable to the object. For example, the frame may be arranged with an exterior that is connectable to an inner side of an object which surrounds the frame with a framing or a wall portion, whereby the connection between the object and the frame may include an adjustable screw connection by which the relative position between the frame and the object is adjustable. The position of the frame inside the object can be arranged such that the object is at level with the frame or reaches pass the frame in that end of the frame which faces the ceiling or wall, such that the object is brought into contact with the wall or ceiling in the first arresting position. Another modification includes a mounting means providing adjustable distance from a supporting wall or a ceiling. Where appropriate a mounting plate may for example be arranged for adjustment of a distance between the arms and the mounting plate, or arranged for adjustment of a distance between the mounting plate and the wall or the ceiling.

Another feasible modification includes a step-less adjustment of the frame. This embodiment may be realized, for example, by metal plates supported on the inner side of the frame, and against which the arms are detachably secured by attraction from magnets which are carried on the arms. In addition, or in the alternative, the frame and arms may be arranged to be detachably secured in relative position by friction generated through any suitable surface configuration on the frame and on the arms. A fixed first arresting position may otherwise be preferred also in those embodiments wherein the frame is adjustably securable in the additional arresting positions.

These and other modifications derivable from the foregoing description are comprised in the scope of invention as defined in the accompanying claims.

1. A mounting means for selective mounting of an object (1) for illumination or for transmission of light from a light source arranged behind the object, comprising two or more arms (5) which are arranged in one end (7) to be mounted so as to depend from a ceiling or to project from a wall, and in another and free end (6) are arranged to detachably engage, by a biasing force, in one of at least two alternative arresting seats (10, 16, 17) arranged to this purpose on an inner side of a frame (4) carrying said object, wherein a first of said arresting seats (10) is arranged to hold the frame into contact with the ceiling or the wall, and a second arresting seat (16; 17) is arranged to hold the frame while forming a gap (14) between the frame and the ceiling or wall.

2. The mounting means of claim 1, wherein the frame (4) extends in an axial direction from a first end to a second end, and the arresting seats are realized as depressions or grooves running in parallel in the circumferential direction of the frame, for at least a portion of the length of the frame, and the arms (5) are formed in their free ends with a projection (11), respectively, dimensioned for engagement into said groove or depression.

3. The mounting means of claim 2, wherein the projection (11) and the first arresting seat (10) are shaped to provide a wedging action resulting from engagement by the projection.

4. The mounting means of claim 3, wherein other arresting seats (16; 17) are shaped to provide a snap lock resulting from engagement by the projection (11).

5. The mounting means of claim 3, wherein the projection (11) and the first arresting seat (10) comprise slide surfaces (12, 13) which generate in cooperation a biasing force (A) in one axial direction of the frame only.

6. The mounting means of claim 1, wherein one end of the arms (5) is secured in a supporting mounting plate (20).

7. The mounting means of claim 6, wherein the arms are adjustably secured in the mounting plate (20), and adjustable in directions which are parallel with the main plane of the mounting plate.

8. The mounting means of claim 6, wherein the mounting plate (20) carries sockets (22) for one or more light sources (8).

9. The mounting means of claim 8, wherein the mounting plate (20) is arranged to be mounted in an attachment (21) for a ceiling lamp.

10. The mounting means of claim 1, wherein the arms (5) run angularly or arcuately between the ends (6, 7) of the arms.

11. The mounting means of claim 1, wherein the arms (5) are made of a flexible material.

12. The mounting means of claim 11, wherein the arms (5) are made of leaf springs which are bent to the shape of a part-circular or exteriorly rounded bulge (11) in the engaging ends of the arms.

13. The mounting means of claim 1 wherein the frame (4) runs uninterruptedly in the circumferential direction and in a first axial end carries a seal (9) which is arranged to be brought into contact with a wall or ceiling when the arms (5) engage the first arresting seat (10).

14. The mounting means of claim 1, wherein the first and second arresting seats (10, 16, 17) are formed in a separate element (18) which is connectable to the frame.

15. The mounting means of claim 1, wherein the frame (4) in its second end is arranged to carry a translucent or an opaque object (1), such as a translucent front panel (1), an opaque front panel (1′), or a translucent lighting object.

16. The mounting means of claim 4, wherein the projection (11) and the first arresting seat (10) comprise slide surfaces (12, 13) which generate in cooperation a biasing force (A) in one axial direction of the frame only.

17. The mounting means of claim 7, wherein the mounting plate (20) carries sockets (22) for one or more light sources (8).
